(19) United States
(12) Patent Application Publication
(10) Pub. No.: US 2011/0246398 A1
(43) Pub. Date: Oct. 6, 2011

(54) Leveraging to Minimize the Expected Multiplicative Inverse Assets

(76) Inventor: Rory G. Mulvaney, (US)

(21) Appl. No.: 13/052,065

(22) Filed: Mar. 19, 2011

Related U.S. Application Data
(60) Provisional application No. 61/320,483, filed on Apr. 2, 2010.

(51) Int. Cl. G06Q 90/00

(52) U.S. Cl. 705/500

(57) ABSTRACT

The question of how much should be placed at risk on a given investment, relative to the total assets available for investment, is basically that of determining the optimal leverage. An existing well known method for calculating optimal leverage does not appear to be derived from sound principles. The approach taken by the method described in this specification is to optimize the expected future value of a function of the assets, conditioned on the assets having some estimated distribution. Asymptotically over time, the distribution of log-assets becomes Gaussian. Using this analysis, a couple of the more obvious strategies are ruled out, while the strategy of minimizing the reciprocal expected assets yields an elegant result that can also be interpreted in some sense as minimizing the risk of bankruptcy. It seems this strategy is particularly relevant for insurance companies, financial security ratings, and financial leveraging.

Patent application reference of benefit: U.S. Provisional Patent application No. 61/320,483, filed Apr. 2, 2010, current status: Pending, titled “Leveraging to Minimize the Expected Multiplicative Inverse Assets” [1], by Rory Mulvaney.

### 1 TECHNICAL FIELD

A very important high-level strategy in finance relates to the amount of money to place at risk, or equivalently, how much leverage to apply. In addition to being a topic in the field of finance and actuary science, this is also a field related to probability theory, because financial time series are often analyzed using probability distributions. The invention claim seems to fit most appropriately into the U.S. patent classification 705/36R, on portfolio selection, planning, or analysis.

### 2 BACKGROUND

Leverage can be thought of as a multiplier of the value at risk, controlling the percentage of one's money that is invested or being bet on something. It is of course possible to actually invest multiples of one's assets through borrowing money “on margin” to invest it. However, this specification uses the definition that leverage is always less than or equal to 1. The leverage is a fraction, where the numerator is the portion of assets actually placed at risk as investment, and the denominator is the total portion of the gross assets that are being considered eligible for investment, possibly including available credit, but always less than or equal to the gross available assets. Any optimization is carried out with respect only to these assets considered eligible for investment.

A leverage-dependent criterion (from which the optimal leverage is derived) can be derived from the projected distribution of investment returns using a utility function. Thus there are two important variables in the process: (1) perhaps most importantly, the choice of the utility function, and (2) the choice of the model for the future distribution of returns.

Perhaps the most basic method to predict the future distribution of the logarithm of a stock price is to model it using Brownian motion with drift, also known as a Wiener process with drift. Of course, more advanced models or more domain-appropriate models may be used.

Utility functions are a matter of importance because money is not valued on a linear scale, as illustrated by the St. Petersburg paradox [2, 3]. Bernoulli's 1738 proposed solution to this paradox was that money is probably typically measured on a logarithmic scale.

Literature from several sources on optimizing leverage point to something called the Kelly criterion [4, 5, 6, 7]. According to Chan [5], the Kelly criterion can be applied to continuous financial time series following a derivation from [6], which derives a leverage-dependent criterion in terms of μ and σ′ using a utility function equal to the logarithm of the assets. The quantity μ is the expected value of the simple uncompounded percent gain for a given time period, and σ′ is the standard deviation of the distribution of μ. This derivation by Thorp [6] is summarized by Chan [5] to give the simple formula for the optimal leverage in Expression 1.

$$l = \frac{μ}{{σ}^{′2}} \qquad ( 1 )$$

Chan [5] points out that the Kelly criterion can be used to further optimize the leverage of an asset that was chosen for its optimal Sharpe ratio, because the Sharpe ratio is basically unaffected by leverage.

A patent by Scott, et al. [8] presents the utility function in Expression 2 in terms of the expected wealth E(W), the estimated variance of the wealth Var(W), and the subjective risk tolerance variable τ.

$$U = E ( W ) - \frac{Var ( W )}{τ} \qquad ( 2 )$$

### 3 SUMMARY

### 3.1 Technical Problem

In a first attempt at deriving an optimal leverage criterion, one might evaluate the expected linear utility using a Brownian motion model with drift to model the logarithm of the stock price. However, as will soon be shown, there are problems with both the linear utility function and the logarithmic utility function.

The two parameters for Brownian motion with drift are the growth rate u of the log-unleveraged-price log P, and the standard deviation σ of the increase in the log-unleveraged-price per time period. (Though σ may also be referred to as volatility in this specification, sometimes in other literature volatility is defined differently.) To maintain constant leverage (if the leverage is anything other than 1), transactions need to be continually made while the stock price changes. If constant leverage is continually maintained, the leveraged growth rate is simply lu, and the leveraged standard deviation is simply lσ. This is true because the leveraged change in the log price is log(1+lμᵢ), in terms of the leverage and percent increase μᵢ of the price Pᵢ (distinct from u, the increase in log-price). The Taylor series of log(1+lμl ) is lμ plus terms of order (lμ)² and higher, and because the leverage is continually maintained in small time increments, keeping |lμ|<<1, all terms except lμ in the series may be neglected, and so the growth in the leveraged log-value is directly proportional to l. The direct proportionality of leveraged standard deviation follows from the direct proportionality of leveraged u.

Due to various common effects such as the law of diminishing returns and interest payments on borrowed assets, the leveraged growth rate lu may not actually grow linearly with l for larger values of l, therefore the notation u(l) is introduced as the growth rate per leverage at leverage l, to make it more general by expressing its dependence on leverage. Thus, the leveraged growth rate is expressed (somewhat redundantly, to maintain expression of the proportionality with l) as lu(l), and u(l) by itself would be fairly constant until the larger values of l are reached, where it would fall somewhat. Similar to the leveraged growth rate, the leveraged volatility is expressed as, lσ(l), with σ(l ) denoting the volatility per leverage, at leverage l. For brevity, when l is in the region where leveraged growth is directly proportional to leverage, u=u(l), and accordingly as such for σ.

### 3.1.1 Linear Utility Implies Infinite Leverage

The expected linear utility of a leveraged model of Brownian motion with drift is given by Expression 3, where p(x; m,σ²) would represent a Gaussian distribution in x with mean m and variance σ². Expression 3 computes the expected value of e^{x}, where x represents the log-assets, having a Gaussian distribution specified by Brownian motion with drift, at time T and initial assets A₀. Thus the expected value of e^{x} is the expected value of the assets.

∫_{-∞}^{∞}e^{x}p(x;log(A₀)+lu(l)T,σ(l)²l²T)dx (3)
Evaluation of the integral in Expression 3 yields Expression 4.

$$exp ( \frac{T ( 2 lu ( l ) + {l}^{2} {σ ( l )}^{2} ) + 2 log ( {A}_{0} )}{2} ) \qquad ( 4 )$$

Therefore, maximization, with respect to leverage, of expected assets at time T, implies infinite leverage. Obviously, infinite leverage would result in bankruptcy on the slightest downturn of the stock price, but apparently the rare case of avoiding bankruptcy has such large rewards that it more than compensates for the low value of the bankrupt cases. Apparently, linear utility sacrifices too much in safety for the hope of a very lucky win.

### 3.1.2 Logarithmic Utility Implies Infinite Leverage

Evaluation of the logarithmic utility is achieved by replacing e with x in the integral in Expression 3, to compute the expected log-assets at time T (because the Gaussian distribution is expressed in terms of the logarithm of the assets). The result is given by Expression 5, which again implies infinite leverage upon maximization with respect to leverage.

Tlu(l)+log(A₀) (5)

Looking back at the derivation by Thorp [6, sec. 7.1] of the Kelly criterion from the logarithmic utility function, reveals that the distribution of future returns was modeled not using Brownian motion with drift in the log-price, but instead modeled using an ad-hoc distribution where the uncertainty seems to be symmetric around the mean in the linear prices (not in the log-prices). It would seem more reasonable for the distribution to be asymmetric and skewed in the linear space, due to presumed exponential growth. This is probably the reason for the discrepancy between the analysis in Expression 5 and that given by [6, sec. 7.1].

### 3.2 Solution to Problem

Upon the above presentation of the infinite leverage problem with both linear and logarithmic utility, the hypothesis may readily be made that perhaps it works to instead minimize the multiplicative inverse of the assets [9, sec. 9]. More generally, one might propose a utility function with the goal of minimizing the expected value of y^{-p}, where y represents the random variable for the assets, and p is a positive real number. The expected value of this generalized utility function may be measured conditionally on a distribution given by the drifting Brownian motion model of the logarithm of assets, by replacing e^{x} in Expression 3 with e^{-px}, because e^{-px}=exp(−plog(y))=y^{-p}. Evaluation of that integral leads to Expression 6.

$$exp ( - \frac{T ( 2 plu ( l ) - {p}^{2} {l}^{2} {σ ( l )}^{2} ) + 2 p log ( {A}_{0} )}{2} ) \qquad ( 6 )$$

Minimization of Expression 6 leads to maximization of the simpler criterion

$$log ( {A}_{0} ) + ( lu ( l ) - \frac{1}{2} {pl}^{2} {σ ( l )}^{2} ) T . \qquad ( 7 )$$

Dropping the asset term (because it is not dependent on leverage) and dividing by T, it becomes the maximization of

$$lu ( l ) - \frac{{pl}^{2} {σ ( l )}^{2}}{2} . \qquad ( 8 )$$

This is very similar to the criterion offered by Scott, et al. [8], listed above in Expression 2, except for the important difference that Expression 8 uses its mean and variance variables computed using the logarithm of asset levels, rather than the linear asset levels used by Scott, et al. (in [8], the wealth was multiplied by the return rate plus 1 in EQ#1 of that reference, so the wealth was being measured on a linear scale). Differentiating Expression 8 with respect to l, and assuming lu(l)=lu, and lσ(l)=lσ, (i.e., if l is in the region where the leveraged growth rate grows linearly with leverage), and solving for l, leads to the optimal leverage where the criterion is maximized:

$$optimal leverage , {l}_{opt} = \frac{u}{p {σ}^{2}} . \qquad ( 9 )$$

To fully specify the utility function and optimal leverage, it seems most reasonable to set p=1 in the 3 prior formulas [9, sec. 9], making the objective to minimize the multiplicative inverse of the assets. (It should be noted that, despite the similarity between Expression 9 using p=1, and Expression 1, the parameters used have quite different definitions.) The primary motivation for this choice of p is that, intuitively, the risk of bankruptcy seems inversely proportional to the amount of assets, and thus this objective would effectively seek to directly minimize the risk of bankruptcy. The term “bankruptcy”, simplified here from its normal definition, is used in the sense that A₀, the total portion of gross assets considered eligible for investment (also used as denominator component of the leverage) reaches zero.

This utility function differs from the linear and logarithmic utility functions in that the perceived value improves more slowly when the assets are large, as can be seen by observing that the derivatives of the linear, logarithmic, and multiplicative inverse utility functions are proportional to 1, 1/y, and 1/y², respectively. With the multiplicative inverse utility function, it takes a 50% chance of a 100% gain to offset a 50% chance of a 33% loss, because ½*½+½*1/(⅔)=1, yielding no change in the expected reciprocal assets.

### 3.2.1 Combination of Multiple Investments

An additive combination of several investment components, each having a separate growth rate and volatility, may be analyzed using the above analysis by first combining the separate components into a single expected value of the growth and volatility. Notably, if money is borrowed, the interest rate and principal repayment rate (and possibly the volatility thereof) should be counted as negative growth.

A linear combination of two investments with pure Gaussian distributed growth rates in the log-assets (u₁, σ₁²) and (u₂, σ₂²) results in a distribution computed using a convolution integral of the two distributions. Though the resulting convolution distribution is not Gaussian in general, only the expected values of the mean and standard deviation matter for this purpose, because asymptotically over larger time intervals, the distribution will be Gaussian with the same mean and standard deviation as that in the convolution distribution. Still, there is no simple exact mathematical expression (without using integrals) to compute the resulting u or σ². Either a heuristic approximate method would be applied, or the exact values could be computed using numerical integration methods. These numerical computation methods are not discussed in this specification, because they are fairly standard for the field of practice.

If l₁ and l₂ represent the leverage in uncorrelated investments 1 and 2, the resulting overall growth rate u is ƒ(l₁, l₂, u₁, u₂, σ₁, σ₂), and the squared volatility σ² is u²−g(l₁, l₂, σ₁, σ₂), where ƒ and g are given by the convolution-like integrals in Expressions 10 and 11 (using the previously specified Gaussian probability density function p(x; u, σ²)), and h(x, y, l₁, l₂)=ln(l₁e^{x-y}+l₂e^{y}).

$$\begin{matrix}f ( {l}_{1} , {l}_{2} , {u}_{1} , {u}_{2} , {σ}_{1} , {σ}_{2} ) = {\int }_{- ∞}^{∞} {\int }_{- ∞}^{∞} p ( x - y ; {l}_{1} {u}_{1} , {l}_{1}^{2} {σ}_{1}^{2} ) p ( y ; {l }_{2} {u}_{2} , {l}_{2}^{2} {σ}_{2}^{2} ) h ( x , y , {l}_{1} , {l}_{2} ) d x d y & ( 10 ) \\ g ( {l}_{1} , {l}_{2} , {u}_{1} , {u}_{2} , {σ}_{1} , {σ}_{2} ) = {\int }_{- ∞}^{∞} {\int }_{- ∞}^{∞} p ( x - y ; {l}_{1} {u}_{1} , {l}_{1}^{2} {σ}_{1}^{2} ) p ( y ; {l }_{2} {u}_{2} , {l}_{2}^{2} {σ}_{2}^{2} ) {h ( x , y , {l}_{1} , {l}_{2} )}^{2} d x d y & ( 11 )\end{matrix}$$

If the two investments are correlated (i.e. there is nonzero covariance in the distribution of u₁ and u₂), the two integrals in the above analysis should be done in an uncorrelated linearly transformed basis. If M is a decorrelating linear transform matrix, and v is the original linear combination column vector (composed of the leverages and for each investment, l₁ and l₂), the vector Mv is the new linear combination of the original untransformed distributions to calculate via the integrals above.

With heuristics or exact numerical methods, different linear combinations of investments may be evaluated, and an optimization method may be applied to find the optimal linear combination that would take advantage of uncorrelated and anti-correlated combinations to reduce the combined volatility, optimally, according to the objective functions in Expressions 7 and/or 8. In this manner a portfolio may be optimally balanced.

### 3.2.2 Trend Dynamics

Due to the complex dynamics of any particular application, there may be identifiable trend changes that outweigh the effects of any shorter-term Gaussian noise process. For example, during a short term temporary linear trend in the log-asset changes, the noise in the short term trend may be Gaussian. However, when the short term trend switches over to another linear rate (and possibly another volatility), the changeover must be recognized quickly and with high certainty if possible; otherwise the Gaussian leveraging strategy will not be optimal. One strategy to mitigate the problem of recognizing short term trends is to simply seek to optimize for longer term trends.

### 3.3 Advantageous Effects of Invention

Intuitively the multiplicative inverse utility function seems to minimize risk of bankruptcy and, most quantifiably, true optimization of leverage is practical with a Brownian motion model with drift, in contrast to using that model with linear and logarithmic utility functions. As Chan pointed out [5], for an investment that was chosen for its good Sharpe ratio, leverage can be further optimized, because the Sharpe ratio is basically unaffected by the leverage. In addition, because the multiplicative inverse has a lower bound on its minimization, it is also a solution to the Super-St. Petersburg Paradox (see [10] for further references regarding the Super-St. Petersburg Paradox). Last, even for distributions of the change in log-assets that aren't Gaussian, the simple optimal leverage formula in Expression 9 (with p=1) is still an optimal strategy in the long term, because even for changes in log-assets uᵢ that have some other distribution in the short term (e.g. monthly changes), the uᵢ measured over a long term (e.g. five-year changes) are still asymptotically Gaussian distributed with the same variance (squared volatility) σ² and average change in log-assets u per time period.

### DESCRIPTION OF EMBODIMENTS

### 4.1 Example: Leveraging in Market Equities

For basic application of optimal leverage from Expression 9 (with p=1), a market equity can be modeled by Brownian motion with drift, parameterized by u and σ. The determination of u and σ from raw data is a separate non-trivial process in itself (for example, see literature on GARCH for volatility estimation), but if it is known or hypothesized that the data are produced from a particular random model with known parameters, then u (also known as the exponential growth rate) is defined as the expected increase (given that particular random model) in the log-price per time period, and a (also known as the volatility) is defined as the standard deviation (given that particular random model) from u of those log-price changes per time period.

Analysis, though straightforward by utilizing the same known principles, can become quite complex if the cost of interest for borrowing under high leverage is taken into account, along with the “risk-free” interest rate, and the volatilities of these rates. Another somewhat complicated matter is how to balance a portfolio containing multiple equities. If multiple investments modeled using Brownian motion with drift in the logarithmic domain are to be combined together, they should be analyzed with the help of convolution methods described in Section 3.2.1.

### 4.2 Example: Leveraging in Blackjack

Suppose that p is the Bernoulli probability of winning a hand of blackjack. Suppose also that ƒ is the chosen fraction of the current assets to bet on each hand, effectively representing the leverage. Then the expected increase in log-assets after one hand is given by Expression 12.

u=plog(1+ƒ)+(1−p)log(1−ƒ) (12)
The variance of the increase is given by Expression 13.

σ²=p(log(1+ƒ)−u)²+(1−p)(log(1−ƒ)−u)² (13)

The number of wins after any number of hands played has a binomial distribution, and for a large number of hands that distribution becomes Gaussian. Given that n hands are played, Expression 14 shows that the only random variable involved in the increase in log-assets is the number of wins w (because ƒ and n are constants), and the expression is linearly dependent on w. Thus the distribution of the increase in log-assets after a large number of hands is also Gaussian distributed, along with w.

Increase in log-assets=wlog(1+ƒ)−(n−w)log(1−ƒ) (14)
Because the future distribution of log-assets is Gaussian, the optimal leverage criterion for Gaussian distributed changes in log-assets from Expression 9 (with p=1 in that expression) can be directly applied using Expressions 12 and 13. Simple numerical optimization (or a table lookup) is needed to find the value of the leverage ƒ that satisfies the optimal leverage criterion. A simple trial and error search algorithm would suffice to solve it, because it involves optimization of only 1 parameter, ƒ (p, the probability of winning each hand, is fixed).

### 4.3 Example: Leveraging with Debt

The root objective of minimizing the reciprocal assets seems to imply that the assets must be positive, in order for the objective to be applicable. However, because the reason for minimizing the reciprocal assets is to avoid bankruptcy, the objective given in Expression 7 also functions in cases where the net assets are negative, simply by considering the assets in the criterion in Expression 7 to be equal to A₀, the amount used in the denominator component of the leverage (as defined in Section 2)—the amount of assets considered eligible for investment, which could include available debt.

If the debt taken has a repayment schedule, as opposed to debt without a repayment schedule such as that in a margin account, the repayment requirements usually increase with time, degrading the growth rate in the future. Thus to maintain low risk of bankruptcy in the future, a forecast is required of the earnings and volatility, and preferably their dependence on leverage, through time. Given this general forecast, the goal should be to apply a debt payoff and investment strategy (controlling the leverage through time) that aims for a steady exponential growth rate in the assets (which are considered eligible for investment) while basically maximizing the minimum, over time t, of the expected value of the function

$$F ( t ) = log ( {A}_{0} ) + {\int }_{0}^{t} ( l ( t ) u ( t , l ) - \frac{1}{2} {l ( t )}^{2} {σ ( t , l )}^{2} ) T d T , \qquad ( 15 )$$

where F (t) is the objective function from Expression 7 modified with p=1, as well as giving time dependence based on the forecast of u and a, and integrating over the time-dependent portion of the function.

The optimal amount of debt to carry has also been determined, because both the debt payoff schedule and the possibility of taking additional debt were considered in the optimization process.

### 4.4 Example: Leveraging in Insurance

Over the long term, the insurance premium per unit of insurance averages out to be greater than the average cost resulting from insurance claims, per unit of insurance, allowing the insurer to provide even more units of insurance that earn greater profits in total, probably resulting in exponential growth while the market expands. Sale of insurance is a type of financial investment, because having the ability to pay out claims means that money must be held in reserve as an investment. However, because the cost of claims over a time period is actually a random variable c, the amount of the investment should probably be considered as being the exponential of the expected value of the logarithm of the claims over that time period, or exp(E[log(c)]).

Denoting the random variable for claims as c and denoting r as the (relatively) certain amount of revenue, the growth rate u (with leverage=1) is calculated as u=log(r)−E[log(c)]. The variance in the growth of log-assets for an interval of time T is basically computed as Tσ²=Var(Σᵢ₌₁^{T}uᵢ)=TE[(log(r)−log(c)−u)²]. Here the second equality is due to the fact that the variance of a sum of independent random variables is the sum of variances of the variables.

Knowing u and a, the analyses from Sections 3.2 and 4.3 are now applicable for the determination of the optimum safe leverage in terms of the optimal expected cost in claims that can be safely paid out. Leverage should be continually tuned to keep it approximately constant, as discussed in Section 3.1. This tuning of the leverage is done by buying and selling excess units of insurance or some other well-quantified financial instrument to offset the risk of a good or bad year for insurance claims. These transactions could take place in some type of market with other insurers and possibly reinsurers.

The problem mentioned about trend dynamics in Section 3.2.2 should be less troublesome to predict in insurance, compared to equity markets, because insurance claims are probably less dependent upon complex quickly-changing social factors.

### INDUSTRIAL APPLICABILITY

Despite its simplicity, minimization of the expected multiplicative inverse assets is a non-obvious leveraging strategy, distinguished by straightforward analysis, and potentially applicable by any financial entity as their root leveraging optimization criterion. The log-normal distribution leveraging criterion in Expression 7 (along with its simpler component in Expression 8) would be particularly applicable for managing risk by insurance companies, credit rating, portfolio balancing, securities investment, company earnings history analysis, and financial advisement.

### References

[1] R. Mulvaney, “Leveraging to minimize the expected multiplicative inverse assets,” U.S. Provisional 61/320,483, Apr. 2, 2010.
[2] D. Bernoulli, “Exposition of a new theory of the measurement of risk.” Econometrica, vol. 22, pp. 22-36, 1954, translated to English by Louise Sommer, originally published 1738.
[3] S. Russell and P. Norvig, Artificial Intelligence: A Modern Approach, 2nd ed. Prentice Hall, 2002, ch. 16.3.
[4] J. Kelly, Jr., “A new interpretation of information rate,” Bell System Technical Journal, vol. 35, pp. 917-926, 1956.
[5] E. Chan, Quantitative Trading: How to Build Your Own Algorithmic Trading Business. Wiley, 2008.
[6] E. O. Thorp, “The Kelly criterion in blackjack sports betting, and the stock market,” in Proceedings of the 10th International Conference on Gambling and Risk Taking, Montreal, June 1997.
[7] W. Poundstone, Fortune's Formula. Hill and Wang, 2005.
[8] J. Scott, C. Jones, J. Shearer, and J. Watson, “Enhancing utility and diversifying model risk in a portfolio optimization framework,” U.S. Pat. No. 6 292 787, Sep. 18, 2001.
[9] R. Mulvaney and D. S. Phatak, “Regularization and diversification against overfitting and over-specialization,”

University of Maryland, Baltimore County, Computer Science and Electrical Engineering TR-CS-09-03, April 3 2009.
[10] B. Hayden and M. Platt, “The mean, median, and the St. Petersburg paradox,” Judgement and Decision Making, vol. 4, no. 4, pp. 256-272, June 2009.

1. For asymptotically Gaussian distributions of growth in the logarithm of assets, the derivation and invention of the strategy to achieve a stronger financial position, guided by the objective function of growth and volatility given in expression 7, and its implied formulas in Expressions 8 and 9, for values of the constant p ranging from 4/5 to 5/4, inclusive (most preferably 1).
